(19) United States
(12) Patent Application Publication
(10) Pub. No.: US 2005/0188634 A1
(43) Pub. Date: Sep. 1, 2005

(54) Laminate suspension system

(76) Inventors: Nelson Bolton, Trumbauersville, PA (US); Novis Smith, Philadelphia, PA (US)

Correspondence Address: John Lezdey & Associates;Suite 302, 4625 East Bay Drive, Clearwater, FL, 33764, US

(21) Appl. No.: 10/675,044

(22) Filed: Sep. 30, 2003

(51) Int. Cl. E06B 3/00; E04H 5/00

(52) U.S. Cl. 52/235

(57) ABSTRACT

A glazing unit comprising at least one monolithic glazing element bonded to at least one layer of a polymer having embedded therein at least one element of a fastening means adapted for mounting to a support structure. This construction provides and integrated connecting arrangement for the mechanical fastening of monolithic glazing units to a support structure to obtain a glazing assembly. A plurality of monolithic glazing units form glazing assemblies which when fixed in a planar array define a continuous smooth surface useful as exterior glazing facades. A clear gain is made, according to the invention is the simplicity of the installation of glass glazing facades to provide increased use in architectural designs. The invention is applicable to any glazing unit whether single, laminated, and/or multiple glazing elements are used.

### FIELD OF THE INVENTION

The present invention relates to a glazing unit and particularly a novel glazing unit having unique means for mechanically fastening such glazing units to be fixed to a supporting structural glazing assembly for forming a continuous facade having an extensively smooth outer surface from such glazing units.

### DESCRIPTION OF THE PRIOR ART

Various technological arrangements are known for mounting glazing units to provide the aesthetical and architectural benefits of continuous glazed facades which are typically fixed on high rise buildings. Generally the glazed facade assembly in the form of glass panels or units is mechanically secured to a substructure of the facade. The substructure is mounted on the outside of a load bearing building skeleton of metal or reinforced concrete. However, the means for mechanical fastening for this purpose involves some projecting parts and/or providing fastening holes through the layers of glass which distort the outer surface of the panels.

In an attempt to obtain the desired smooth outer surface of the facade form which no parts are projecting and the individual glass units remain integral, the glass panes were mounted exclusively by means of adhesive bonding. For safety reasons, building authorities have not generally permitted such glass facades without positive locking. Moreover, the prior art methods are limited to certain thickness of glass.

The current practice in facade construction is described in U.S. Pat. No. 4,481,868 to McCann, which is incorporated herein by reference, discloses mechanically fastening sections of glass panels to the supports of a building. That patented glass assembly comprises a planar array of sealed multiple glazing units each comprising two opposed spaced sheets with a seal between the sheets defining a sealed gas space, which units are secured to supporting members with the outer surface of the units sealed edge-to-edge, at least some of the units being secured to the supporting members by a mechanical fixing passing through the outer sheets of the units outside the seals of the units. In a preferred embodiment each unit is a multiple glazing unit which is secured to the supporting member by bolts whose heads are countersunk into holes countersunk in the outer face of the unit outside of the seal of the unit. The outer surface of the outside sheet of the glazing unit is protected against destructive stress cracks by cushioning with bushings and washers placed between the bolt and the glazing surfaces. The bushings and washers prevent glass-to-metal contact and prevent damage to the glazing sheets.

There are several disadvantages in the patented glass assembly directed to aesthetics and the manner of assembly. The holes required to accommodate the attaching bolts weaken the entire unit, destroy the integrity and smooth surface of the outer panel. The flat headed bolts even if countersunk into the glass detract from the uninterrupted planar appearance of the outside of the assembly. The necessity to carefully drill through multiple layers of glass and align these pieces constitutes a difficult and costly manufacturing problem. The drilling of glass to produce a countersunk hole usually requires two steps and may entail considerable glass breakage. Likewise, if the holes are not properly aligned, during assembly of the facade the tightening procedure will result in breakage resulting in down time and material loss.

The McCann patent does not disclose any laminated structure. The critical feature of the present invention is a glazing unit having embedded in an ionomer polymer layer a mechanical securing element.

It is known in U.S. Pat. No. 2,310,402 to Dennison, which is incorporated herein by reference, to provide a glass insulation unit of a glass laminate wherein a metal border is embedded in plastic interlayers.

U.S. Pat. No. 4,029,942 to Levin, which is incorporated herein by reference, discloses bus bars embedded in transparent laminates to provide electrical contacts to heat windows for defrosting and defogging.

U.S. Pat. No. 4,799,346 to Bolton and Smith, which is incorporated herein by reference, discloses an attachment member mounting embedded in a transparent resinous layer of a laminate glazing unit. The attachment member mounting is fastened to a frame or support structure by bolting or clamping. In a preferred embodiment a resistance means for preventing removal of the mounting is in form of protrusions which extend from the plane of the member on that portion which is embedded within the interlayer. Among the resins suitable for use as interlayers for the laminate are mentioned ionomer resins.

The present case distinguishes from the Bolton and Smith patent in that the present invention is a glazing unit integrated with a mechanical securing element which eliminates the need for the attachment mounting element of the patent.

### SUMMARY OF THE INVENTION

According to the present invention a novel glazing unit is disclosed having at least one mechanical securing element embedded within a polymer layer, preferably an ionomer, bonded to at least one monolithic glazing element to provide an integrated mounting system enabling such units to be fixed to a support without disruption or distortion of the monolithic structure of the glazing element. A plurality of glazing units are capable of being mounted in a planar array on the outer surface of a building having a concealed framework to produce a continuous glazed facade.

In its broadest aspect the present invention relates to a novel glazing unit comprising: at least one monolithic glazing element bonded to at least one polymeric layer having embedded therein a mechanical securing element selected from male or female interactive fastening means. Either the male of the female securing element can be embedded in the polymer. The invention is applicable to any glazing construction ranging from single laminates and/or multiple panes.

When a laminated multiple glazing unit such as a double glazing unit is involved, a hole or slot is formed in the internal glazing element to accommodate the stem of a male securing element. In a glazing facade assembly procedure the male stem is aligned with and passes through a hole or slot in a support structure regardless which securing element is embedded.

The external and/or internal glazing sheets may be any well known commercial plate, float or sheet glass composition. Also plastics which are well known in the plastics art such as polycarbonate polymers may be used either alone or in combination with glass glazing or with other plastics. An ionomer copolymer forms excellent strong bonds with glass, metals and plastic materials.

The polymers useful in this invention for forming a bonding layer (single glazing) or laminate interlayer and embedding a mechanical securing element are those capable of providing the high tensile strength necessary to support multiple glazing units. Furthermore, the ionomer copolymer layer maintains the integrity of the glazing untis when they are subjected to physical impact or thermal stress.

It has been found that ionically crosslinked copolymers of ethylene-methacrylic or acrylic acid or ethylene-methacrylic or acrylic-acid-polyamine provides the toughness, high clarity, and superior tensile strength, are most useful. The ionomers are at least partially neutralized with an alkali metal cation.

The mechanical securing element which is embedded within the ionomer layer may be any male-female coacting mechanical fastening means. As mentioned above, either the male or the female securing elements can be embedded. The mechanical securing elements in combination are a means for securing the glazing unit to a supporting frame or other load bearing structure. Preferably, a bolt and nut provides a mechanical connection by simply screw-tightening the glazing unit against the supporting structure. Other mechanical securing combinations include snap together couplings, clamps, and the like.

A compressable and/or flexible material may be interposed at metal to glass or metal to plastic interfaces in the form of bushings, gaskets, sleeves, seals, or washers.

It is the primary object of the present invention to provide a glazing unit having means for securing the glazing unit to a frame or other structural support.

Another object of this invention is to improve the integrity of the glazing unit in the frame or structural support when subjected to high physical impact or thermal stress.

A further object of this invention is to ensure a safe retention of the glazing unit in position even in case of the breakage or cracking of the glazing element.

A still further object of this invention is that the glazing unit secured in the manner disclosed appears devoid of any projection or visible fixing element.

Yet another object of this invention is to provide a plurality of an improved glazing unit for producing a planar array on a building exterior having an uninterrupted surface, uniformity and continuity in reflection and color.

Still yet another object of the invention is to provide a laminate for the fixed windows of automobiles and aircraft such as windshields and canopies.

Other objects and a fuller understanding of the invention will be had by referring to the following description and claims of a preferred embodiment, taken in conjunction with the accompanying drawings, wherein like reference characters refer to similar parts throughout the several views.

### BRIEF DESCRIPTION OF THE DRAWINGS

FIG. 1 is a cross-sectional view of a single glazing unit having a male mechanical securing element, a bolt head, embedded in a bonded ionomer copolymer layer.

FIG. 2 is a cross-sectional view of a double glazing unit having a female mechanical securing element, a capped nut, embedded in the bonded ionomer copolymer layer.

FIG. 3 shows a sectional view of a plurality of the laminated glass glazing units 20 as illustrated in FIG. 2 forming a glazing assembly of planar rectangular panels.

FIG. 4 is a cross-sectional view of a double glazing unit having a female securing element in the form of a flange and stud.

FIG. 4A is a cross-sectional view along line y-y of FIG. 4.

### DETAILED DESCRIPTION OF THE PREFERRED EMBODIMENTS

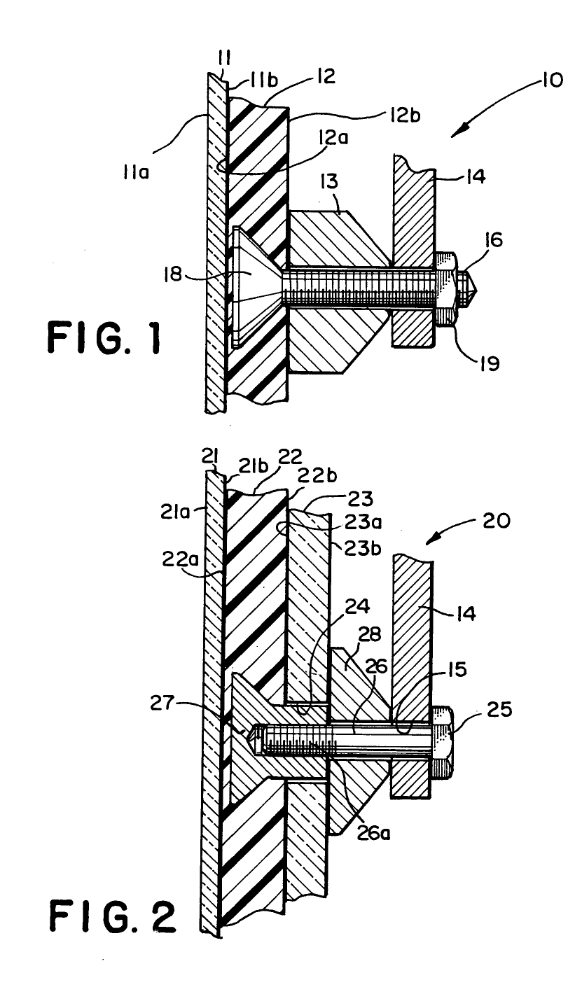

Referring to drawings FIGS. 1 to 4, there are illustrated a novel single glazing unit, a laminated glazing unit and a glazing assembly according to this invention. A plurality of these glazing units when arranged in a planar array and mechanically secured to a concealed structural support member of a building form a glazing assembly having a monolithic facade with aesthetical and practical architectural benefits.

The simplest application of this invention as shown in FIG. 1 involves a single monolithic glazing unit 10 which comprises a monolithic external glazing element 11 such as a glass glazing having a smooth outer surface 11a and an inner surface 11b bonded to an internal polymer layer 12 which is preferably an ionomer having surfaces 12a and 12b and embedded therein at least one male mechanical securing element 7 such as bolt 17. The bolt 17 comprises a flat head 18 and a threaded stem 16. As shown in the figure, the flat head 18 is totally embedded within the polymer layer 12 in a fixed position with the threaded stem 16 projecting from the glazing unit 10. A female mechanical fixing element nut 19 is connected to the threaded stem 16 to form a mechanical securing assembly and enables the monolithic glazing unit to be secured to a structural support 14 (partially shown) by tightening the nut 19. The inherent properties of adhesive strength and high tensile strength of the polymer locks the flat head 18, increases the load bearing capacity of the mechanical securing assembly and accepts increased load bearing pressure.

In practice the installation of the monolithic glazing unit 10 to a support structure 14 involves passing the threaded end 16 of the bolt 17 through a bushing 13 and circular hole 15 of support structure 14. The hole 15 has a diameter slightly larger than the threaded stem 16 to provide adequate clearance to compensate for the monolithic glazing unit 10 which is secured to the support structure 14 by tightening nut 19 on the threaded stem 16 at face 12b of the ionomer layer 12. The tightening action causes pressure to be distributed through the bushing 13. The bushing 13 is of sufficient size and elasticity to accommodate relative movements between the ionomer layer 12 and the structural support 14.

A plurality of the monolithic glazing units 10 may be employed in a planar array as a building facade or an interior ceiling and wall assembly in which each of the laminated glazing units are secured to a support structure by mechanical securing assembly wherein at least one element of the assembly is embedded in the polymer layer of the laminate.

The term “monolithic” as used herein relates to a glazing element to be integral, i.e., without holes or fragmentations.

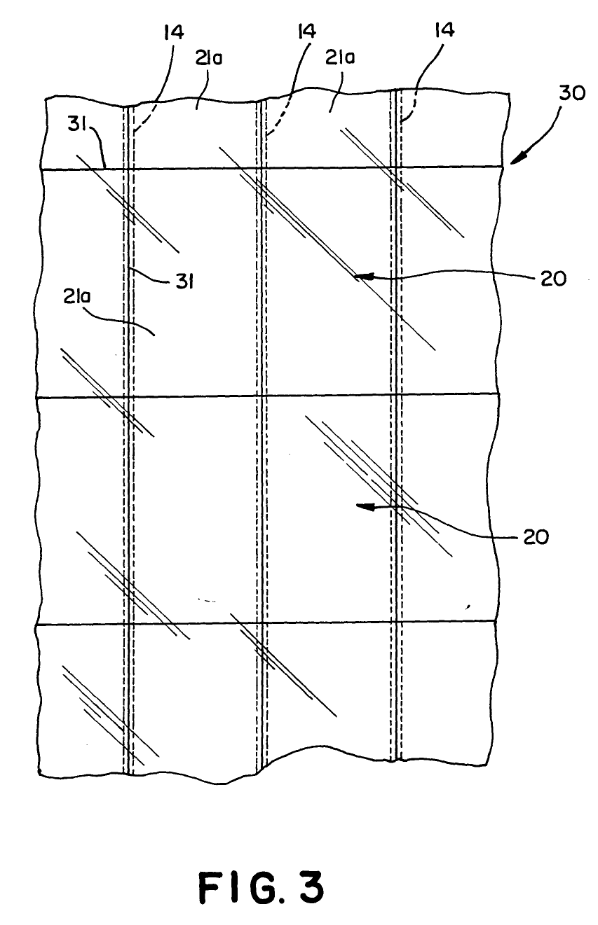

In FIG. 2 there is shown a laminated multiple glazing unit, specifically a glass double glazing unit 20 comprising an external glass element 21 having an outer surface 21a and an inner surface 21b and an internal glass element 23 also having outer and inner surfaces 23a and 23b which are bonded together with polymer interlayer 22. The interlayer 22 has embedded therein a female securing element such as a capped nut 27. A circular fixing hole 24 is formed through the internal glass element 23 and has a diameter slightly larger than that of the mechanical fixing element 26. In this case the male fixing element is a bolt 26 comprising a head 25 and a threaded end which is sized to engage the embedded capped nut 27. As seen in FIG. 3, the laminated glazing assembly 30 (FIG. 2) is constructed from a plurality of laminate multiple glazing units. Each glazing unit has an uninterrupted outer surface which can be secured to a concealed supporting framework to provide an uninterrupted planar appearance of the outside of the assembly. Preferably, the multiple glazing unit is a laminated glass double glazing unit 20 as described in FIG. 2. This glazing unit 20 is integrated with the mechanical connection with bolt 26. The facade assembly procedure for attachment of each glazing unit 20 typically involves units having rectangular or square shapes with the mechanical securing element embedded in each corner. In this case the threaded end of bolt 26 is passed through hole 15 in support structure 14 through bushing 28 and through fixing hole 24 to connect with embedded capped nut 27.

After engaging the capped nut 27 the bolt head 25 is torqued to exert force on bushing 28 which distributes the pressure to the inner surface 28 which distributes the pressure to the inner surface 23b thus securing the glazing unit 20 to the support structure 14. Various arrangements of compressible elastomeric gaskets, washers and seals in addition or in place of the bushing shown may be used to avoid glass-to-metal contact and prevent damage to the glazing sheets. Such arrangement and choice of compressable and/or flexible material is clearly known in the glazing art.

The critical feature of the invention resides in that at least one of the mechanical securing elements is embedded in an ionomer or polymer layer or interlayer. The mechanical securing assembly useful in this invention results from the interaction of male-female components either of which may be embedded in the ionomer layer without any consequence.

The terms “external” and “internal” as used herein refer to the position of these elements relative to the facade.

FIG. 3 illustrates a laminated glass double glazing assembly 30 comprising a planar array of laminated glass double glazing units 20 as shown in FIG. 2 each of which are mechanically secured at their respective corners to conceal support members 14 behind the array which are part of a structural framework to which the glazing assembly 30 is secured. The outer glass glazing surface 21a of the double glazing units 20 are positioned edge-to-edge so as to appear to be continuous. However, a small gap between adjacent edgers can remain and this can be sealed with a silicone sealant as indicated at 31 if required.

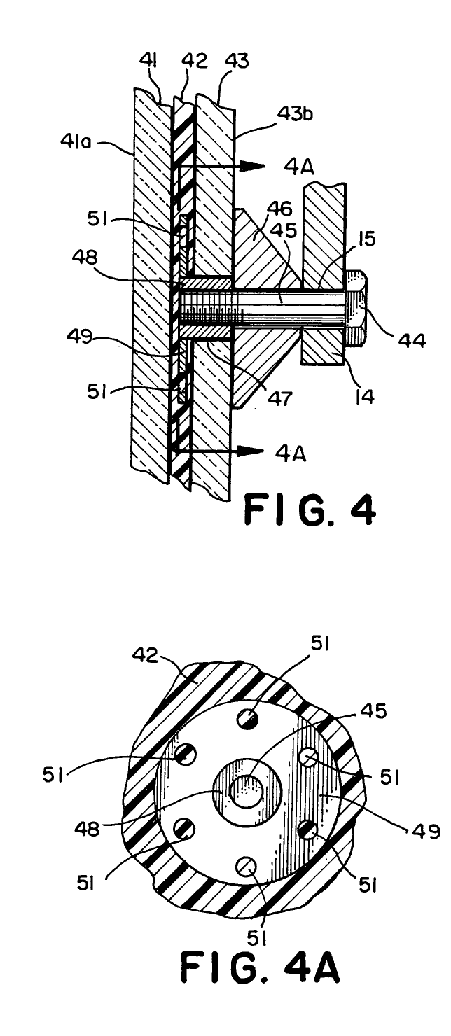

FIG. 4 shows another embodiment of this invention in which a female mechanical securing element 50 as shown in FIG. 4A is embedded in the polymer layer 42. The construction of the securing element 50 involves a metal flange 49 attached to an internally threaded stud 48. Additionally the flange has a plurality of spaced apart circular holes 51. These holes provide additional surface areas for adhesion to the ionomer polymer layer 42. The laminated double glazing unit 40 comprises external glass glazing element 41 and internal glass glazing element 43 bonded together with the polymer interlayer 42 having embedded therein the female securing element 50. A bolt 45 having a threaded end provides the necessary male securing element. The bolt head 44 in torqued to tighten the glazing unit for attachment to a support structure 14. In this construction the weight of the glazing unit is borne by the polymer layer 42. Preferably, the flange and stud are welded together and employ stainless steel as the material of construction.

The glazing material preferred for either external or internal elements may be any with known commercial plate float or sheet glass compositions. The glass may be tempered or non-tempered or chemically strengthened. Synthetic polymers to which the ionomer polymer resin provides good adhesion which includes polycarbonate resins, fused acrylic/polycarbonate resins, polyurethane, etc. The invention contemplates the use of one or more inner or outer layer of various polymer combinations preferably the inner layer is an ionomer layer and has embedded therein the mechanical securing element. The glazing material may range from transparent to opaque, may be tinted or deeply colored. The glazing material may include coatings which provide specific properties or special effects such as reflecting and non-reflecting properties, ultraviolet radiation absorbing, etc.

The thickness of the glazing may vary from about 8 mm to 19 mm for the external unit and between about 5 to 15 mm for the internal unit. The thickness of the ionomer polymer layer or interlayer will range from 3 to 60 mm. The good adhesion and the high tensile strength of the ionomer polymer allows for multiple glazing units in excess of three or more glazing elements. Further the thickness of each element may vary which allows for a wide latitude in glazing design.

Thermoplastic interlayer usable in the invention must be capable of strongly bonding to a rigid panel such as glass to form an impact-dissipating layer in a laminated safety glass assembly. Exemplary thermoplastics include poly(ethyl-vinyl acetate), poly(ethylene-vinyl acetate-vinyl alcohol), poly(ethylene-methyl, methacrylate-acrylic acid), polyurethane, plasticized polyvinyl chloride, polycarbonate, etc. Polyvinyl butyral (PVB) and more particularly partial PVB containing about 10 to 30 weight % hydroxyl groups expressed as polyvinyl alcohol is preferred. Such partial PVB further comprises about 0 to 2.5 weight % acetate expressed as polyvinyl acetate with the balance being butyral, expressed as polyvinyl butyral. The non-critical thickness of the thermoplastic sheet can vary and is typically about 0.25 to 1.5, preferably about 0.35 to 0.75 mm. PVB sheet is commercially available from Monsanto Company as Saflex® sheet and E.I. Dupont de Nemours and Co. as Butacite® polyvinyl butyral resin sheeting.

Preferred interlayers are ionomers such as disclosed is U.S. Pat. Nos. 5,763,062 and 4,663,228 which are herein incorporated by reference. Most preferable are the ionomers which have been at least partially neutralized with an alkali metal cation and a polyamine.

The mechanical securing assembly can be of a typical mechanical fastening means, besides the nut and bolt assembly mentioned above, various retention clamps, clips and means for snap together engagement are usable for this purpose. The glazing assembly is not only easy to install by virtue of the simple construction of the fixing means but the integrity of the external units is maintained so that continuous uninterrupted planar appearance of the outside assembly is provided. Suitable metals useful as materials for the mechanical securing assembly include aluminum and steel but preferably corrosion resistant materials such as stainless steel and high impact plastics including fiberglass and thermoset phenolic-aldhyde polymers.

Fixing inserts of compressable and/or flexible materials are used at metal-glazing material contact areas to prevent stress cracking as well as to improve impact resistance, compensation for thermal expansion and to secure watertightness. Fixing inserts of elastomeric material in form of bushings, gaskets, sleeves, spacers and washers are used in bolt-fixing insert, nut-fixing assembly systems. The specific securing assembly of the mechanical connection will vary depending on the size and design of the individual glazing units and the final facade design.

### EXAMPLE 1

A windshield is prepared by inserting a 3-4 mm interlayer of an ionomer (NOVIFLEX® sold by AGP Plastics, Inc. of Trumbauersville, Pa.) between two sheets of glass of 10 mm thickness in which aligned holes are prebored partially in the ionomer and completely through the inside layer of the glass. A stainless steel stud having a tapered head with a standard 82 degree taper was inserted into the ionomer. The barrel of the stud is 20-25 mm in diameter and the head is tapped with a 9 mm coarse thread. A metal or plastic bushing is used to hold the inner glass layer in place. The assembly is placed in a so called “polymer” bag of the type disclosed in U.S. Pat. No. 3,311,517 to Keslar et al. The bag comprises an outer ply of polyethylene terephthalate and an inner ply of polyethylene bonded thereto. The bag is inserted into a second bag evacuated and sealed. The unit is placed in an autoclave at 225° F. for three minutes under 150-200 psi pressure in a vacuum. The vacuum causes the ionomer to flow and seal the opening and set the bolt.

If required, a large washer or metal strip with plastic cushioning may be used to tighten the assembly and to provide further security in the event that the outer glass is broken. Depending upon the size and weight of the laminate several fastening means can be used.

The form of the invention shown and described herein represents illustrative preferred embodiments and variations thereof. It is understood that various changes may be made without departing from the gist of the invention as defined in the claims.

### EXAMPLE 2

The preparation of a sample glass unit similar to that described in FIG. 2 was conducted as follows:

A cross-linked partially neutralized ethylene-acrylic acid ionomer resin was added to the resin port of a small extruder having an extruding barrel temperature which was maintained at 165-205° C. A film (50-60 mils) was extruded and cut into 12 squares of about 25.4 mm, stacked to about 13 mm thickness between two sheets of tempered glass one of which had a hole of 12 mm drilled in the center of the sheet. A 9 mm stainless steel capped nut was placed in the hole. The glazing unit was placed in a vacuum bag comprising an outer ply of polyethylene terephthalate and an inner ply of polyethylene bonded thereto. The bag was inserted into a second bag of the same material, evacuated and sealed. The sealed bag assembly was placed in an autoclave at 125° C. for three minutes under 150-200 psi in a vacuum. The autoclave was reduced in pressure and cooled to room temperature. The bag assembly was removed from the autoclave and plastic wrappings were removed from the glass unit. This procedure embedded and fixed bonded the capped nut. A 9 mm stainless steel bolt was connected to and screwed into the fixed capped nut.

The glazing unit was then tested with tension applied at the head of the bolt. The indicated a strong adhesive bond of the ionomer polymer with the capped nut and a high tensile strength of the inherent in the ionomer layer.

It is intended that the primary use of the units constructed in accordance with the invention will be in the commercial glazing industry, particularly when flash glazing is required. In addition to this architectural glazing which can provide a desirable external appearance due to the uninterrupted planar array of an outside assembly, the glazing units can provide the same effect for a decorative interior wall or ceiling. The glazing units of this invention can be used for automobiles and other vehicles. Multiple glazing units of this invention can be used in security glazing for banks, prisons, armored trucks, inter alia.

It will be understood that the above-described embodiments of the invention are only for the purpose of illustration. Additional embodiments, modifications and improvements can be readily anticipated by those skilled in the art based on a reading and study of the present disclosure. Such additional embodiments, modifications and improvements may be fairly construed to be within the spirit, scope, and purview of the invention as defined in the claims.

1. A glazing unit adapted for mounting in a support structure comprising: at least one external monolithic glazing element layer bonded to at least one polymer element layer having embedded therein at least one member of a mechanical fastening means for fixing said unit to the support structure.

2. The glazing unit of claim 1 wherein said mechanical fastening means consists of a fastening mechanism having an interacting male member and a female member.

3. The glazing unit of claim 2 wherein said male member is embedded in an ionomer polymer layer and protrudes for connection to the support structure.

4. The glazing unit of claim 2 wherein said female member is embedded in an ionomer polymer element layer and is connectable to a male member passing through a support structure.

5. The glazing unit of claim 2 wherein said fastening mechanism consists of an interacting bolt and nut arrangement.

6. The combination of the glazing unit of claim 1 and a support frame.

7. The glazing unit of claim 1 further comprising at least one glazing substrate element layer being bonded to at least one external monolithic glazing element by at least one interlayer of an ionomer polymer to form a laminate and wherein at least one of said interlayers of said ionomer polymer element has embedded therein at least one member of said fastening means.

8. The glazing unit of claim 7 wherein said laminate is a double glazing unit comprising an external monolithic glazing element layer and an internal glazing element layer bonded by an ionomer polymer interlayer having embedded therein at least one mechanical fastening means for fixing said unit to a support structure.

9. The glazing unit of claim 1 wherein at least one of the glazing element layers is a glass or a plastic material.

10. The glazing unit of claim 9 wherein said plastic material is selected from the group consisting of polycarbonate polymers, acrylic polymers, polyurethane polymers, poly(alkyl diglycol carbonate) polymers.

11. The glazing unit of claim 1 wherein the polymer is a cross-linked partially neutralized copolymer of an alpha olefin and alpha beta-ethylenically unsaturated carboxylic acid units.

12. The glazing unit of claim 11 wherein said polymer is cross-linked with a polyamine.
